(19) United States
(12) Patent Application Publication
(10) Pub. No.: US 2007/0099499 A1
(43) Pub. Date: May 3, 2007

(54) Leveraged Electronic Plug

(76) Inventor: Jay Victor, Redondo Beach, CA (US)

Correspondence Address: TROJAN LAW OFFICES, 9250 WILSHIRE BLVD, SUITE 325, BEVERLY HILLS, CA, 90212, US

(21) Appl. No.: 11/555,838

(22) Filed: Nov. 2, 2006

Related U.S. Application Data
(63) Continuation of application No. 11/266,130, filed on Nov. 2, 2005.

(51) Int. Cl. H01R 9/05

(52) U.S. Cl. 439/578

(57) ABSTRACT

The present invention is a leveraged electronic plug for audio and video appliances having an easy-to-grip first portion and collar fitted onto the back end of the plug. Locating the first portion and collar behind the body of the plug creates a lever capable of reducing the amount of force necessary to insert or pull out the plug. A flat gripping surface on the collar may be used to place a trademark or another symbol that otherwise could not be placed on the plug.

### CLAIM OF PRIORITY

This application is a continuation application of and claims priority to my co-pending U.S. application Ser. No. 11/266,130, filed on Nov. 2, 2005.

### BACKGROUND OF THE INVENTION

Electronic plugs used in high-end audio-visual appliances often require significant manual efforts to insert and remove. To insert a plug into a socket one must grab onto the plug and push it with a twisting motion. Conversely, to remove a plug a twist-and-pull motion is required. Both the insertion and the removal must overcome a tractional friction force between the metal surfaces of the plug and the socket. Notably, for the optimal performance of electronic appliances the plug connection must be very tight, thus creating a strong frictional force that makes it difficult to insert and remove the plugs. The task of inserting and removing plugs demands substantial manual dexterity because the sockets for the plugs are usually located on a rear, or otherwise hard-to-reach, surface of the appliance unit. Even more manual dexterity is required where the socket area is crowded with other plugs and cables. Prior art solutions merely involved aids for gripping, such as providing a non-slip surface or making the shape of the plug square or hexagonal for easier gripping. To date there has been no solution for reducing the amount of force required to insert or remove the plug.

### DESCRIPTION OF THE PRIOR ART

An electrical plug is generally understood in the art to be a male connector adapted to mate with a female receptacle socket for achieving an electrical connection. Such plugs, typically found at the terminal end of coaxial cables, are generally cylindrical in shape and include four basic components: an outer and an inner tube, an insulator separating the tubes and a conductive member in the center of the plug. (See U.S. Pat. No. 5,160,280). The conductive member is the terminal pin that engages the receptacle socket. Generally, the body of the plug is encased in an insulating material, some of which have grooves to facilitate gripping.

More specifically, at present electronic plugs are commonly coated with heat-resistant insulating outer jackets. The main purpose of the outer jacket is to provide insulation, and often times no thought is given to its usage as a gripping aid. Though some plugs are also provided with a collar for easy gripping, that is typically not an essential design element. For example, U.S. Pat. No. 5,456,611 is directed to a female snap-on plug having a plastic collar, in which it is mentioned as an afterthought that the flange of the collar may be provided with a pair of indents to allow for easy gripping.

Other types of collars found on the back of plugs are resin caps and plug body mitts. These collars, however, do not aid in removing or inserting the plug. For example, in U.S. Pat. No. 5,882,233, it is taught that the collar is made of an insulating material, and no mention is made of the collar as a gripping aid. From the specification, it is surmised that the collar merely has a protective function. In another example, U.S. Pat. No. 6,893,289 describes a body collar that could be characterized as a mitt that helps to maintain a bend in the cable extending from the plug.

In plugs that specifically have a gripping feature, the design is typically based on some variation of a hexagonal nut. As in U.S. Pat. No. 6,241,553, a cylindrical metal plug may be equipped with a hexagonal nut that allows for easier gripping with tool or hand, to facilitate the twisting motions of inserting and removing the plug. In yet another device, as described in U.S. Pat. No. 5,199,901, a cylindrical plug is placed inside a rectangular “keying funnel” that fits snugly into the socket.

In summary, while providing several means for gripping, the prior art does not provide a solution based on the leveraging of force to facilitate the insertion and removal of the plug.

### SUMMARY OF THE INVENTION

The present invention involves an electronic plug with a leveraged gripping surface fitted to the back end of the plug body. The invention facilitates the insertion and removal of the plug by reducing the amount of force required necessary to insert or remove a plug and also by providing an extended grip for handling the plug in hard to reach areas. The two main problems currently encountered by users of electronic plugs involve, first, the amount of force required to insert or remove a tight-fitting plug; and second, the difficulty encountered in manipulating the plug in an area of the appliance unit crowded with plugs and cables. Both problems are addressed by the gripping design in the present invention.

First, the grip design of the present invention creates a lever that elongates the moment arm and reduces the amount of force required to overcome the frictional forces inherent in inserting and removing the plug. Second, the rear placement of the gripping surface provides an extended handle that makes it easier to reach sockets located behind the appliance unit where the space is obstructed by other plugs and cables. In addition, a flat polymer surface of the collar may be used to affix a trademark or a functional symbol that could not otherwise be affixed to the surface of the plug that is metallic and curved.

### BRIEF DESCRIPTION OF THE DRAWINGS

FIG. 1 is a perspective view of an embodiment of a plug.

FIGS. 2a and 2b are perspective views of an alternative embodiment of a plug.

### DETAILED DESCRIPTION OF THE PREFERRED EMBODIMENTS

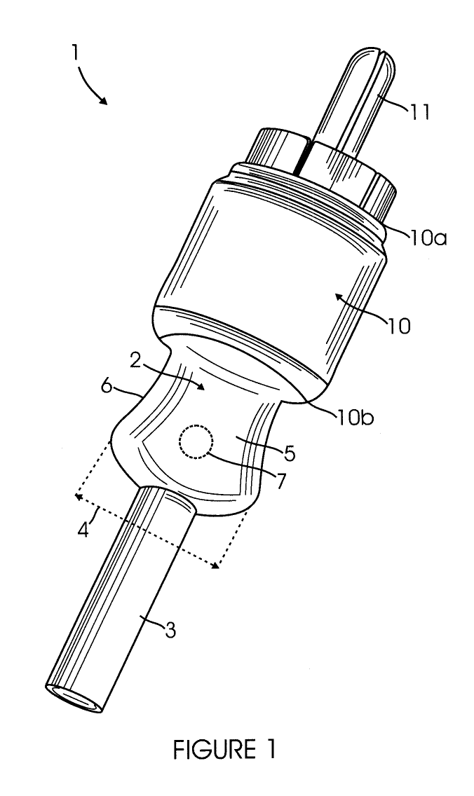

Referring to FIG. 1, in the first preferred embodiment a conventional cylindrical electronic plug 1 having a plug body 10 with a front end 10a and a back end 10b. The front end 10a of the plug body 10 contains a terminal pin 11 and the back end 10b of the plug body is connected to a cord 3 (connection not shown). The plug body 10 is equipped on its back end with a grip collar 2 made of an insulating material. The grip collar 2 is buttressed against the plug body at the junction where the cord 3 is attached to the plug body 10. The grip collar 2, symmetrical relative to the longitudinal axis of the plug 1, has two pairs of gripping surfaces 5 and 6. The two surfaces 5 are flat and wide. The two side surfaces 6 are narrow and concave, forming a skirt shaped grip. The width 4 of grip collar 2 is greater than the diameter of cord 3.

The grip collar 2, with its symmetrical design and concave surfaces, allows for easy gripping and provides a sort of handle to which force can be applied, for example by a thumb in a twisting motion. Further, the gripping surfaces 5 and 6 of the grip collar 2 may be equipped with slits or grooves (not shown) to enhance gripping. Most notably, because grip collar 2 is buttressed against the back end 10b of the plug body 10, it provides greater leverage for insertion and removal of the plug into/from electronic devices. Lastly, the gripping surfaces 5 may optionally bear a trademark or other symbol 7.

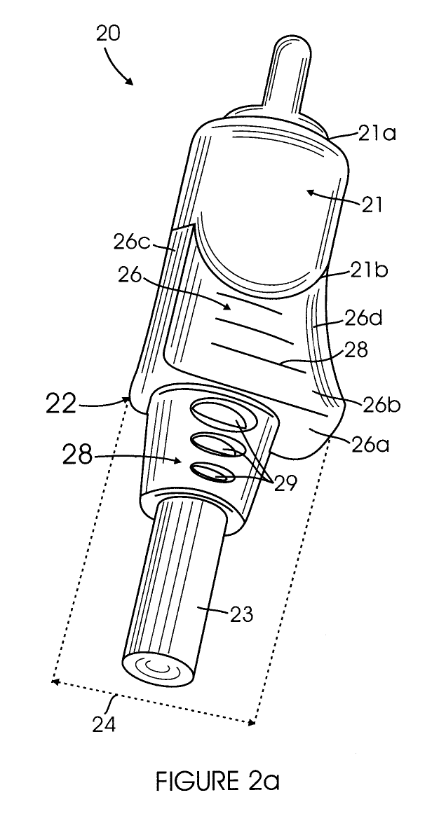

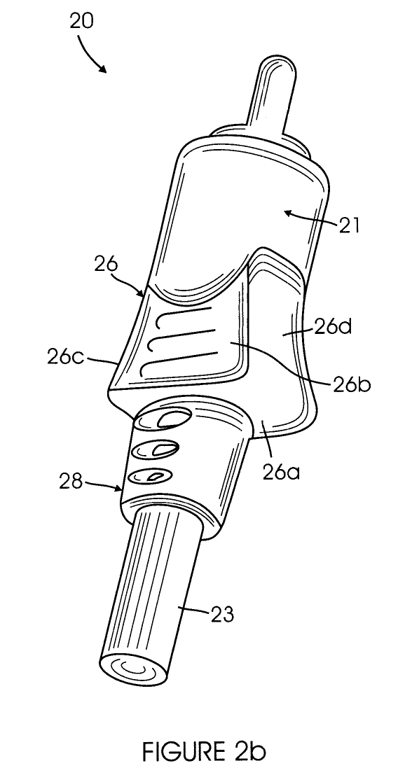

In another embodiment as shown in FIGS. 2a and 2b, the plug 20 has an asymmetrical grip collar 22 comprising a front portion 26 and a back portion 28. The front portion 26 of grip collar 22 is buttressed against the back end 21b of the plug body 21, with the back portion 28 being joined to the base 26a of the front portion 26.

Referring to FIGS. 2a and 2b, the front portion 26 of grip collar 22 is of an asymmetrical polygonal shape, having a base 26a, parallel polygonal side surfaces 26b, a generally flat side surface 26c, and a sloped side surface 26d. The back portion 28 of grip collar 2 is joined to the base of front portion 26. The base 26a of the front portion 26 has a width 24, which is wider than the diameter of the plug body. As such, the width 24, being perpendicular with respect to the axis of rotation of plug 20, provides increased leverage for twisting plug 20 by reducing the torque involved in inserting or removing plug 20.

Further, as shown in FIG. 2a, the parallel polygonal side surfaces have grooves 28 to facilitate gripping of the front portion 26. Similarly, the back portion 28 also has enlarged grooves 29 for easy gripping. It is also to be noted that the sloped surface 26d on the front portion 26 provides a natural gripping surface, especially for pulling upon removal of the plug 20. Although as shown, front portion 26 is asymmetrical in shape, it is to be understood that front portion 26 is not limited to the shape illustrated in the drawings. It is contemplated that front portion 26 can take any shape, symmetrical or asymmetrical, including, for example, a square, rectangle, or a trapezoid.

Because first portion 9 is buttressed against the back end of the plug body, and its width is broader than the diameter of the plug body, first portion 9 will provide increased leverage for inserting and removing plug 1.

While the invention is described in connection with the illustrations, it is understood that it is not intended to limit the invention to the models depicted in the drawings, but on the contrary, it is intended to cover all alternative modifications and equivalents that may be included in the spirit and the scope of the invention as defined by the appended claims.

I claim:

1. A method of facilitating removal of a coaxial electronic plug from an audio or video equipment receptor, comprising the steps of:
providing a gripping collar for said plug, said gripping collar having at least one flat surface, a hollow interior, an opening for allowing an audio or video cable to be passed through said hollow interior, and at least one projection extending substantially perpendicularly to a longitudinal axis of said gripping collar; and
attaching said gripping collar to a rear portion of said coaxial electronic plug, thereby allowing mechanical force to be applied to said gripping collar when said plug is inserted in said receptor to rotate said plug and facilitate removal of said plug from said receptor.

2. The method of claim 2 wherein said gripping collar is made of insulating material.

3. The method of claim 3 where said projection of said gripping collar has at least one wing-shaped projection to accommodate the force of a thumb of the user.

4. The method of claim 3 where said gripping collar bears at least one identifying symbol.

5. A coaxial electronic plug for insertion into a receptor associated with audio or video equipment, the plug comprising:
a main body portion having a front end and a rear end, said front end containing a terminal pin and said rear end being connected to an audio or video cable;
a gripping collar fitted over said cable and connected to the rear end of said main body, said gripping being in direct contact with said cable;
said gripping collar including an opening for said cable and at least one projection that extends substantially perpendicularly to a longitudinal axis of said main body,
said gripping collar including at least one flat surface to which mechanical force may be applied when said plug is inserted in said receptor to cause said plug to rotate, thereby facilitating removal of said plug from said receptor.

6. The coaxial electronic plug of claim 5 wherein said projection has a width that is at least equal to the diameter of said plug.

7. The coaxial electronic plug of claim 5 wherein the width of the said projection is less than the diameter of said plug.

8. The coaxial electronic plug of claim 5 wherein said gripping collar includes at least one groove on said at least one flat surface.

9. The coaxial electronic plug of claim 5 wherein said projection is asymmetrical relative to the longitudinal axis of said plug.

10. The coaxial electronic plug of claim 5 further including at least one concave side.

11. The coaxial electronic plug of claim 5 further including an identifying symbol on at least one surface of said gripping collar.
